(19) United States
(12) Patent Application Publication
(10) Pub. No.: US 2016/0323352 A1
(43) Pub. Date: Nov. 3, 2016

(54) WEB PROXY

(71) Applicant: FORTINET, INC., Sunnyvale, CA (US)

(72) Inventor: Wenping Luo, Coquitlam (CA)

(73) Assignee: FORTINET, INC., Sunnyvale, CA (US)

(21) Appl. No.: 14/698,139

(22) Filed: Apr. 28, 2015

(51) Int. Cl. H04L 29/08; H04L 29/12; H04L 29/06

(52) U.S. Cl. CPC H04L 67/02; H04L 63/0281; H04L 61/1511

(57) ABSTRACT

Systems and methods for establishing a connection context for a remote server by a web proxy are provided before a request for an object hosted by the remote server is received from a client. According to an embodiment, a web proxy receives a request for a web page from a client and forwards the request to a web server for handling. After receiving the web page from the web server, the web proxy forwards the web page to the client. The web proxy extracts a link contained in the web page and establishes a connection context for a remote server of the link without pre-fetching an object of the link from the remote server.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2015, Fortinet, Inc.

### BACKGROUND

1. Field

Embodiments of the present invention generally relate to the field of computer networking. In particular, various embodiments relate to a light weight web proxy that is capable of establishing a context for connecting to a server before a request for accessing the server is received from a client.

2. Description of the Related Art

An explicit proxy is an intermediary device, program or agent, which acts as both a server and a client for the purpose of making or forwarding requests on behalf of other clients. For example, a client can be configured with an explicit proxy and any requests to web servers from the client are directed to the explicit proxy instead of to the web servers. Typically, a web page requested by a client is served through an explicit web proxy by the following steps:
1. A client makes a Transmission Control Protocol (TCP) connection to an explicit web proxy;
2. The client sends a Hypertext Transfer Protocol (HTTP) request with the server's domain name and a Uniform Resource Locator (URL) link for the web page;
3. The explicit web proxy resolves the server's domain name to an Internet Protocol (IP) address through a domain name system (DNS) server;
4. The explicit web proxy makes a TCP connection to the server's IP address;
5. The explicit web proxy forwards the HTTP request to the server through the TCP connection with the server;
6. The explicit web proxy receives an HTTP response from the server and forwards it to the client.

Usually, the web page contains multiple links directed to various objects, some of which are hosted by different servers. Some of the links direct to embedded objects, such as icons, text, images, cascading style sheet (CSS) and scripts files. These files are used for displaying the complete content of the web page to the user. Within a short period of time after the web page is received by the client, the client may send requests relating to the multiple links contained in the web page to the explicit proxy. The proxy may process the links and retrieve the objects requested by the client from multiple servers and return them to the client. At the explicit proxy peer, an average DNS lookup to a domain name of a server takes ˜60-120 ms, followed by a full round-trip (RTT) to perform the TCP handshake with the server. That creates 100-200 ms of latency before the explicit proxy can forward the request. When a web page contains multiple embedded objects, the cumulative latency experienced by the explicit proxy may slow down the user's browsing experience.

To accelerate the process of proxying, object pre-fetching is introduced to explicit proxies. The explicit proxies with pre-fetching functionality may analyze links contained in a web page that is to be sent to a client. The explicit proxy may pre-fetch objects of the links contained in the web page before receiving requests from the client. When requests for the objects are actually received from the client, the pre-fetched objects may be returned to the client so that response times may be reduced.

Object pre-fetching by explicit proxies may reduce the response time relating to requests; however, pre-fetching may consume a lot of resources, such as bandwidth and memory. Such pre-fetching may also waste resources as the pre-fetched objects may never be requested by the client. Therefore, there is a need for light-weight web proxies that can reduce response time for processing requests from client while consume fewer resources than typical object pre-fetching.

### SUMMARY

Systems and methods are described for establishing a connection context for a remote server by a web proxy before a request for an object hosted by the remote server is received from a client. According to an embodiment, a web proxy receives a request for a web page from a client and forwards the request to a web server for handling. After receiving the web page from the web server, the web proxy forwards the web page to the client. The web proxy extracts a link contained in the web page and establishes a connection context for a remote server of the link without pre-fetching an object of the link from the remote server.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates an exemplary network architecture in accordance with an embodiment of the present invention.

FIG. 2 illustrates exemplary functional units of an explicit proxy in accordance with an embodiment of the present invention.

FIG. 3 illustrates exemplary functional units of a pre-process module in accordance with an embodiment of the present invention.

FIGS. 4A and 4B collectively represent a flow diagram illustrating a method for establishing a context for connecting to a server before a request to access the server is received from a client in accordance with an embodiment of the present invention.

FIG. 5 is an exemplary computer system in which or with which embodiments of the present invention may be utilized.

### DETAILED DESCRIPTION

Systems and methods are described for establishing a connection context for a remote server by a web proxy before a request for an object hosted by the remote server is received from a client. According to an embodiment, a web proxy receives a request for a web page from a client and forwards the request to a web server for handling. After receiving the web page from the web server, the web proxy forwards the web page to the client. The web proxy extracts a link contained in the web page and establishes a connection context for a remote server of the link without pre-fetching an object of the link from the remote server.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

If the specification states a component or feature “may”, “can”, “could”, or “might” be included or have a characteristic, that particular component or feature is not required to be included or have the characteristic.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

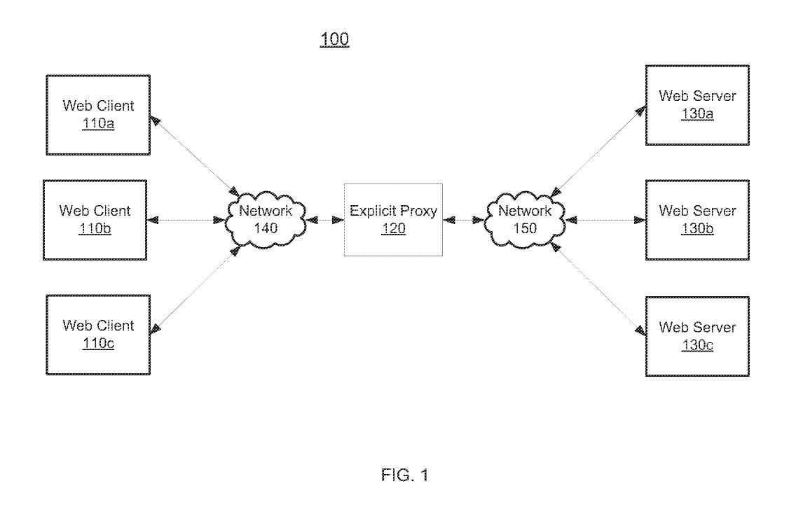

FIG. 1 illustrates an exemplary network architecture 100 in accordance with an embodiment of the present invention. In the present example, network architecture 100 comprises multiple web clients 110a-110c, an explicit proxy 120 and multiple web servers 130a-130c. Web clients 110a-110c are configured to interact with an explicit proxy, such as explicit proxy 120, so that any requests from the clients 110a-110c are directed to explicit proxy 120 over a network 140. Web servers 130a-130c connect to explicit proxy 120 through a network 150 and host objects that can be accessed by explicit proxy 120. Networks 140 and 150 may be any type of data network configured to connect multiple computing devices, such as a local area network (LAN), a wireless LAN (WLAN), a wide area network (WAN), the Internet or a combination of such networks. Explicit proxy 120 is a proxy server logically interposed between clients and servers, and passing HTTP requests/responses between the clients and servers. Although the present embodiment shows an explicit proxy, it will be apparent to one skilled in the art that other kinds of proxies, such as a transparent proxy, may also be used in embodiments of the present invention.

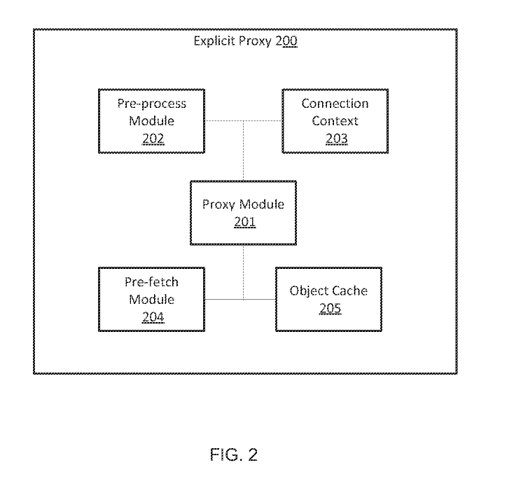

In the context of the present example, explicit proxy 120 analyzes links contained in a web page that is being sent to a client, such as web client 110a, and predicts if a link is likely to be accessed by web client 110a within a short time after the web page is received by web client 110a. If the link is determined to be likely to be accessed, explicit proxy 120 may establish a connection context for a server, such as web server 130a, associated with the link before a request for the link is actually received by explicit proxy 120 from web client 110a. The connection context established by explicit proxy 120 may include an IP address of the server resolved from a DNS server, a TCP connection with the server, a ranking of the server and/or other pre-scan results associated with the link. Explicit proxy 120 may pre-process one or more of the links contained in a web page requested by a client; however, in one embodiment, explicit proxy 120 does not pre-fetch the objects associated with such links from web servers so as to avoid the heavy burden on explicit proxy 120. In some embodiments, explicit proxy 120 may perform pre-fetching, but only after making a determination that (i) pre-fetching is appropriate based on current conditions and/or (ii) the pre-fetched object is likely to be requested by the client within a short time frame of receipt of the web page by the client. Exemplary structure and operation of explicit proxy 120 is described in further detail below with reference to FIG. 2.

FIG. 2 illustrates exemplary functional units of an explicit proxy 200 in accordance with an embodiment of the present invention. In the present example, explicit proxy 200 includes a proxy module 201, a pre-process module 202, a connection context 203, a pre-fetch module 204 and an object cache 205. Proxy module 201 is configured for forwarding HTTP requests and responses between clients and servers as in prior art. Additionally, however, when proxy module 201 forwards a web page that is received from a server to a client, it analyzes the web page to check if any link contained within the web page meets one or more pre-fetching conditions (e.g., is likely to be accessed by the client within a short time frame after the web page is received by the client). If proxy module 201 determines pre-fetching is appropriate under the current conditions (e.g., resource load) of the explicit proxy 200 and that a link meets the one or more pre-fetching conditions, the object associated with the link can be pre-fetched by pre-process module 202 from the server associated with the link before a request relating to the link is received by explicit proxy 200. As those skilled in the art will appreciate, objects associated with links may include, but are not limited to, documents (e.g., other webpages (HTML files), text files, PostScript files, word processing files, Portable Document Format (PDF) files and the like) and/or other current or future web resources (e.g., images, audio files, video files, multimedia files, audio streams, video streams and/or multimedia streams).

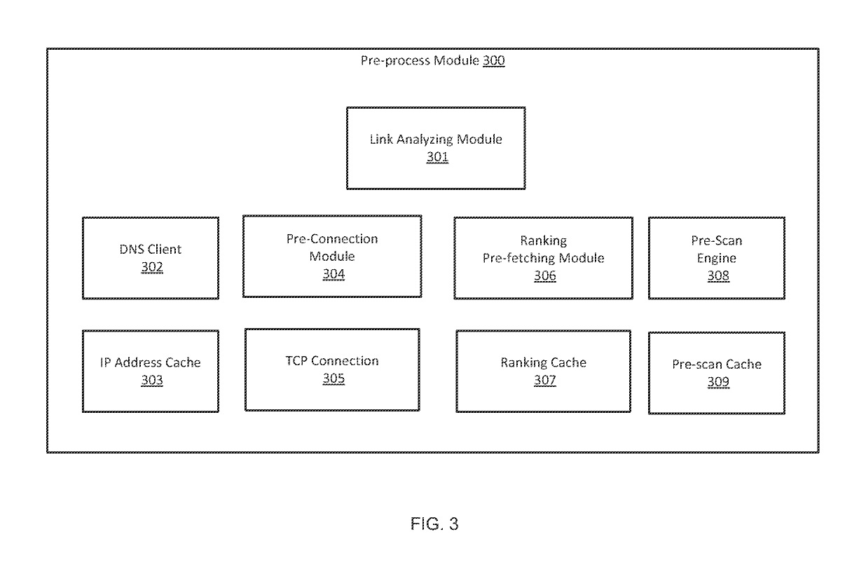

The pre-fetched object is cached in object cache 205. When a request for the link is received by explicit proxy 200 from the client (as anticipated), the pre-fetched object associated with the link is forwarded to the client from object cache 205. However, if pre-fetching of objects from servers consumes too much resources of explicit proxy 200, proxy module 201 may switch to pre-processing of the links contained in the web page by pre-process module 202 instead of actually pre-fetching the objects associated with the links. The pre-processing of a link associated with a server by pre-process module 202 may include resolving a domain name to its IP address from a DNS server, establishing a TCP connection with the server, retrieving a ranking of the server and/or the link from a reputation database and/or other pre-scanning relating to the link. After the pre-processing, a connection context 203 is established for the server associated with the link. After the request for the link is received by explicit proxy 200 from the client, the object associated with the link may be fetched from the server through the established connection context 203. The time to process the request by explicit proxy 200 is shortened because a connection context with the server has been established in advance—before the request for the link has been received by explicit proxy 200. The resources required by establishing connection context 203 are less than those required for pre-fetching and caching the objects from the server. Therefore, explicit proxy 200 with link pre-processing functionality as described herein is a light-weight proxy compared with a proxy that always blindly performs pre-fetching. Exemplary structure and operation of pre-process module 202 is described in further detail below with reference to FIG. 3.

FIG. 3 illustrates exemplary functional units of a pre-process module 300 in accordance with an embodiment of the present invention. In the present example, pre-process module 300 includes link analyzing module 301, DNS client 302, IP address cache 303, pre-connection module 304, TCP connection 305, ranking pre-fetching module 306, ranking cache 307, pre-scan engine 308 and pre-scan cache 309.

Link analyzing module 301 is used for determining whether a link contained in a web page should be pre-processed by pre-process module 300. In an explicit proxy, after a web page is received from a server, the web page is sent to link analyzing module 301 for pre-processing. Usually, a web page contains multiple links to objects that are hosted by multiple servers. Link analyzing module 301 may extract links contained in the web page. Usually, it is not necessary to establish a connection context for all links contained in the web page as some links are not likely to be requested by the client. Therefore, link analyzing module 301 may determine which of the links, if any, contained in the web page are likely to be accessed within a short time after the web page is received by a client. For example, links directed to embedded objects of the web page, such as icons, text, images, cascading style sheet (CSS) and scripts files, are likely be requested by the client after the web page is received by the client. On the other hand, links that may be requested only when they are clicked/selected by a user are not likely to be accessed in a short time. Pre-process module 300 may also contain a set of policies to determine whether a link should be pre-fetched or pre-processed. The pre-processing of a link may be determined based on information associated with the link and/or the running or operational environment of the explicit proxy. The information associated with the link may include but is not limited to the time of receipt of the web page, the user of the client, the type of the link and/or the ranking of the link. The running environment of the explicit proxy may include characteristics of and/or the current status of memory, CPU and/or bandwidth of the explicit proxy. For example, the administrator of explicit proxy may define a rule that allows links to be pre-fetched if enough resources of the explicit proxy are available. When resources are insufficient, the links are pre-processed and pre-fetching of the objects may be avoided or temporarily disabled. In another example, the links may be pre-processed in the evening when explicit proxy is not busy. In a further example, links may be pre-processed or pre-fetched for important/priority (e.g., VIP) users while no acceleration operation may be used for regular users. In another example, a link that has a higher ranking in a reputation database may be allowed to be pre-processed. It will be apparent to those skilled in the art that the above mentioned information and other conditions, as well as their combinations may be used in determining whether a link should be pre-processed or pre-fetched by an explicit proxy.

After a link is identified for pre-processing by link analyzing module 301, the link can be pre-processed by different modules of pre-process module 300.

If the link comprises a domain name, DNS client 302 may resolve the domain name to an IP address through a DNS server. After the domain name is resolved, the corresponding IP address can be cached within IP address cache 303. When the request for the link is actually received from the client, the explicit proxy may establish a connection with the server associated with the link using the cached IP address for the server. The processing of requests by the explicit proxy of the present embodiment is quicker than that of regular processing because the latency caused by domain name resolution is removed from the processing of the request.

If a connection to the server associated with the link is allowed be to established based on the result of link analyzing module 301, a connection to the server of the link is established by pre-connection module 304 using the IP address that was previously resolved by DNS client 302 if the link contains a domain name. The connection is stored within TCP connection 305. When the request for the link is actually received from the client, the explicit proxy may fetch the object associated with the link through the established connection with the server. The processing of requests by the explicit proxy of the present embodiment is quicker than that of regular request processing because the latency caused by establishing a connection with the server is removed from the processing of the request.

If ranking information of the link and/or the server is needed in future actions that will be performed when the request for the link is actually received, the ranking information may be fetched by ranking pre-fetching module 306 from a ranking/reputation database provided by a security vendor. The pre-fetched ranking information can be cached in ranking cache 307. When the request for the link is actually received from the client, the explicit proxy may determine whether the access to the link is allowed based on the cached ranking of the link. The processing of request by the explicit proxy of the present embodiment is quicker than regular request processing because the latency caused by fetching the ranking from the reputation database is removed from the processing of the request.

If link analyzing module 301 determines that a link is to be pre-scanned based on its policies, the link is pre-scanned by pre-scan engine 308. Pre-scan engine 308 may scan the link to determine whether the link directs to a virus, malware or any other risks based on a reputation database or a blacklist provided by a security vendor. The results of the pre-scan can be cached in pre-scan cache 309. When the request for the link is actually received from the client, the explicit proxy may determine whether access to the link is allowed based on the cached pre-scan results. The processing of the request by the explicit proxy of the present embodiment is quicker than regular request processing because the latency caused by scanning the link is removed from the processing of the request.

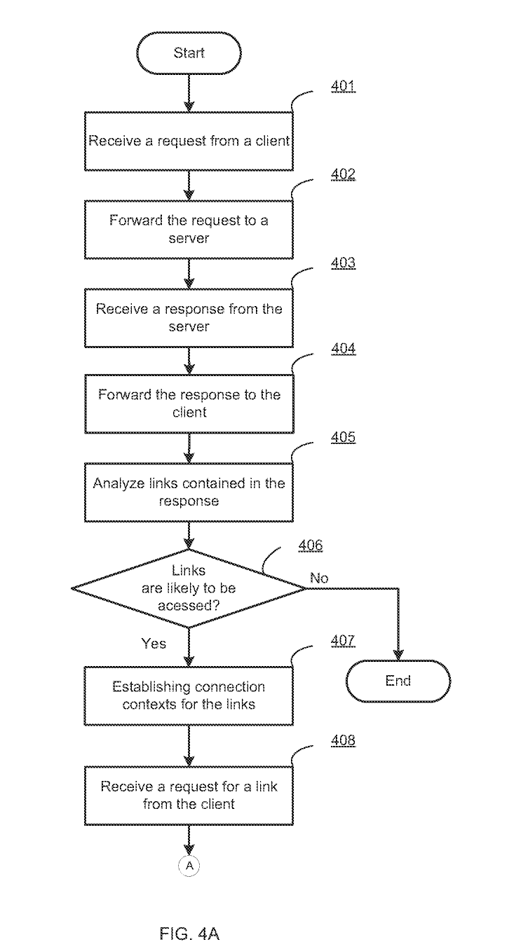

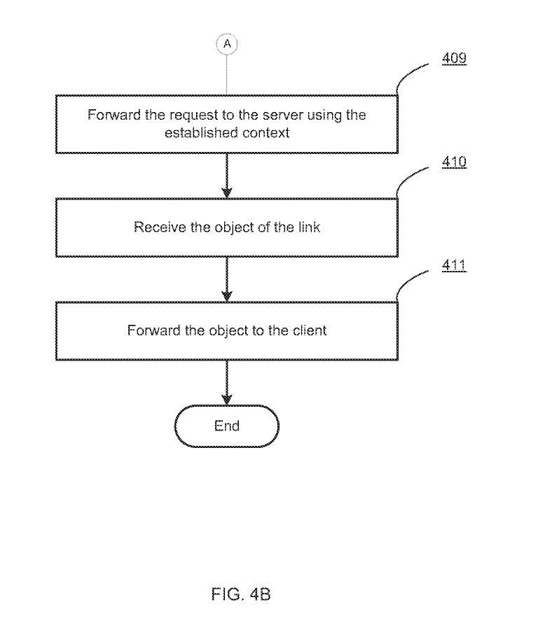

FIGS. 4A and 4B collectively represent a flow diagram illustrating a method for establishing a context for connecting to a server before a request to access the server is received from a client in accordance with an embodiment of the present invention.

At block 401, an explicit proxy receives a request from a client, such as a web browser. The client is configured to communicate with the explicit proxy so that web requests from the client are directed to the explicit proxy instead of directly to web servers that host content. The request may comprise a URL of a web page that is hosted by a web server.

At block 402, the request is forwarded by the explicit proxy to the web server for handling.

At block 403, the explicit proxy receives the web page from the web server.

At block 404, the web page is forwarded to the client by the explicit proxy.

At block 405, the explicit proxy analyzes the web page that has been received from the web page. For example, links contained in the web page may be extracted.

At block 406, the explicit proxy determines whether links contained in the web page meet one or more pre-fetching conditions. For example, the explicit proxy may determine whether links contained in the web page are likely to be accessed by the client within a short time based on information associated with the links. Examples of links that may be determined to be likely to be accessed within a short time are links that are directed to embedded objects that are to be displayed as a part of the web page. In another example, a security vendor may collect information regarding links that are commonly accessed by multiple clients over multiple networks and the Internet and maintain a database for such commonly accessed links. The explicit proxy may access the database and determine a link is likely to be accessed by the client if it is a commonly accessed link in the database.

If the links are not likely to be accessed by the client within a short period of time, no more action is taken by the explicit proxy.

If the links are determined likely to be accessed by the client in a short time, the explicit proxy establishes connection contexts for the links at block 407. Connection contexts may include IP addresses resolved for domain names included in the links, TCP connections to servers of the links, rankings of the links and/or pre-scan results associated with the links. Depending on the policies defined by the administrator of the explicit proxy, the links may be pre-processed and corresponding connection contexts may be established in advance of receiving requests for the links from the client. If domain names are included in the links, they can be resolved to IP addresses from a DNS server. The IP addresses may be cached locally. The explicit proxy may establish TCP connections with servers associated with pre-processed links. The ranking information of links may be fetched from a remote ranking database and cached locally. The links may be pre-scanned by the explicit proxy to determine if the links are safe for access. The results of such pre-scanning may also be cached.

At block 408, the explicit proxy receives a request for a link contained within the web page that was sent to the client by the explicit proxy.

At block 409, the request is forwarded to the corresponding server using the connection context that has been established in advance. If the IP address of the server associated with the link has been resolved and cached within the connection context, the explicit proxy may establish a TCP connection with the server using the cached IP address. The request is then forwarded to the server through the TCP connection. If the TCP connection has been established in advance, the request may be forwarded to the server through the pre-established TCP connection. Moreover, if the link that is requested by the client is determined to need scanning based on rankings, the explicit proxy may fetch the ranking information of the link from a local cache. If the link needs to be scanned for any threads, pre-scan results may be fetched from the connection context. As the establishing of the necessary connection contexts with appropriate servers has been performed during a pre-processing phase, the latency for processing the request for the links by the explicit proxy is less than that would be incurred by a traditional explicit proxy.

At block 410, the object that was previously requested by the client is received by the explicit proxy from the server.

At block 411, the object is forward to the client by the explicit proxy.

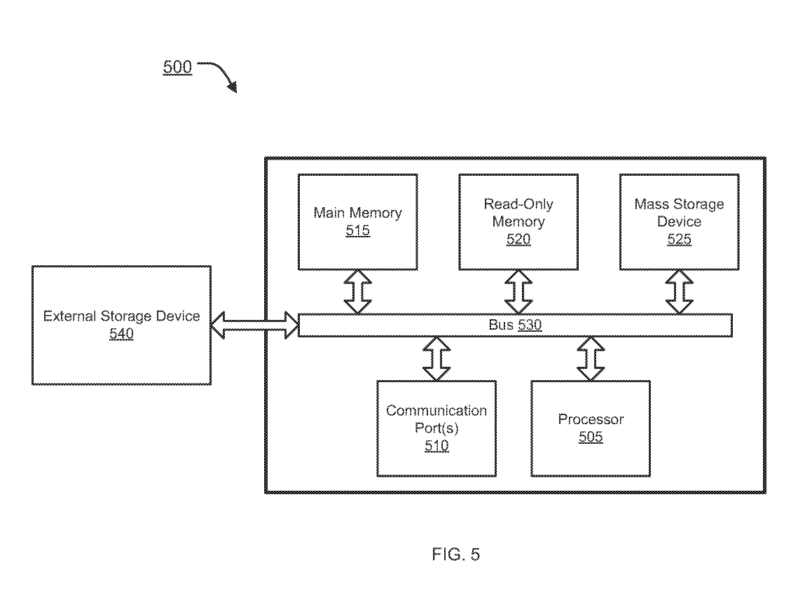

FIG. 5 is an example of a computer system 500 with which embodiments of the present disclosure may be utilized. Computer system 500 may represent or form a part of an explicit proxy (e.g., explicit proxy 120 or explicit proxy 200), an intermediate network device (e.g., a web proxy server) implementing an explicit proxy, a network appliance, a server or a client workstation.

Embodiments of the present disclosure include various steps, which have been described in detail above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 500 includes a bus 530, a processor 505, communication port 510, a main memory 515, a removable storage media 540, a read only memory 520 and a mass storage 525. A person skilled in the art will appreciate that computer system 500 may include more than one processor and communication ports.

Examples of processor 505 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 505 may include various modules associated with embodiments of the present invention.

Communication port 510 can be any of an RS-232 port for use with a modem based dialup connection, a 10/100 Ethernet port, a Gigabit or 10 Gigabit port using copper or fiber, a serial port, a parallel port, or other existing or future ports. Communication port 510 may be chosen depending on a network, such a Local Area Network (LAN), Wide Area Network (WAN), or any network to which computer system 500 connects.

Memory 515 can be Random Access Memory (RAM), or any other dynamic storage device commonly known in the art. Read only memory 520 can be any static storage device(s) such as, but not limited to, a Programmable Read Only Memory (PROM) chips for storing static information such as start-up or BIOS instructions for processor 505.

Mass storage 525 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 530 communicatively couples processor(s) 505 with the other memory, storage and communication blocks. Bus 530 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 505 to system memory.

Optionally, operator and administrative interfaces, such as a display, keyboard, and a cursor control device, may also be coupled to bus 530 to support direct operator interaction with computer system 500. Other operator and administrative interfaces can be provided through network connections connected through communication port 510.

Removable storage media 540 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
receiving, by a web proxy, a request for a web page from a client;
forwarding, by the web proxy, the request to a web server for handling;
receiving, by the web proxy, the web page from the web server;
forwarding, by the web proxy, the web page to the client;
extracting, by the web proxy, a link contained within the web page, wherein the link is associated with an object hosted by a remote server; and
facilitating, by the web proxy, subsequent request processing for the link by establishing a connection context for the remote server without pre-fetching the object from the remote server.

2. The method of claim 1, wherein said establishing a connection context for the remote server further comprises:
resolving, by the web proxy, a domain name of the remote server to an internet protocol (IP) address through a domain name system (DNS) server; and
caching, by the web proxy, the IP address.

3. The method of claim 2, wherein said establishing a connection context for the remote server further comprises establishing, by the web proxy, a connection to the remote server using the cached IP address.

4. The method of claim 1, further comprising:
receiving, by the web proxy, a request for the object from the client;
fetching, by the web proxy, the object from the remote server through the connection context that has already been established for the remote server before receipt of the request for the object from the client.

5. The method of claim 1, further comprising:
determining, by the web proxy, whether the link is likely to be requested by the client after the web page is received by the client; and
establishing, by the web proxy, the connection context for the remote server when a result of said determining is affirmative.

6. The method of claim 1, wherein said establishing a connection context for the remote server further comprises:
prefetching, by the web proxy, a ranking of the link from a reputation database;
caching, by the web proxy, the ranking of the link; and
determining, by the web proxy, whether the link is allowed to be accessed based on the cached ranking when a request for the link is received by the web proxy.

7. The method of claim 6, further comprising responsive to receiving a request for the object from the client, determining, by the web proxy, whether the object is allowed to be accessed by the client based on the cached ranking of the link.

8. The method of claim 1, wherein said establishing a connection context for the remote server further comprises:
pre-scanning, by the web proxy, the link to determine whether the link is allowed to be accessed by the client;
caching, by the web proxy, a result of the pre-scanning; and
responsive to receiving a request for the link from the client, determining, by the web proxy, if the link is allowed to be accessed by the client based on the cached pre-scanning result.

9. The method of claim 1, wherein the object comprises an icon, text, an image, a cascading style sheet (CSS), a script or a web page.

10. A web proxy server comprising:
a non-transitory storage device having tangibly embodied therein instructions representing an explicit proxy; and
one or more processors coupled to the non-transitory storage device and operable to execute the explicit proxy to perform a method comprising:
receiving a request for a web page from a client;
forwarding the request to a web server for handling;
receiving the web page from the web server;
forwarding the web page to the client;
extracting a link contained within the web page, wherein the link is associated with an object hosted by a remote server; and
facilitating subsequent request processing for the link by establishing a connection context for the remote server without pre-fetching the object from the remote server.

11. The web proxy server of claim 10, wherein said establishing a connection context for the remote server further comprises:
resolving a domain name of the remote server to an internet protocol (IP) address through a domain name system (DNS) server; and
caching the IP address.

12. The web proxy server of claim 2, wherein said establishing a connection context for the remote server further comprises establishing a connection to the remote server using the cached IP address.

13. The web proxy server of claim 10, wherein the method further comprises:
receiving, by the web proxy, a request for the object from the client;
fetching, by the web proxy, the object from the remote server through the connection context that has already been established for the remote server before receipt of the request for the object from the client.

14. The web proxy server of claim 1, wherein the method further comprises:
determining whether the link is likely to be requested by the client after the web page is received by the client; and
establishing the connection context for the remote server when a result of said determining is affirmative.

15. The web proxy server of claim 10, wherein said establishing a connection context for the remote server further comprises:
prefetching a ranking of the link from a reputation database;
caching the ranking of the link; and
determining whether the link is allowed to be accessed based on the cached ranking when a request for the link is received by the web proxy.

16. The web proxy server of claim 15, wherein the method further comprises responsive to receiving a request for the object from the client, determining whether the object is allowed to be accessed by the client based on the cached ranking of the link.

17. The web proxy server of claim 10, wherein said establishing a connection context for the remote server further comprises:
pre-scanning the link to determine whether the link is allowed to be accessed by the client;
caching a result of the pre-scanning; and
responsive to receiving a request for the link from the client, determining if the link is allowed to be accessed by the client based on the cached pre-scanning result.

18. The web proxy server of claim 10, wherein the object comprises an icon, text, an image, a cascading style sheet (CSS), a script or a web page.
